(19) United States
(12) Patent Application Publication
(10) Pub. No.: US 2026/0236172 A1
(43) Pub. Date: Aug. 13, 2026

(54) Hybrid Block Structures for High Read Bandwidth

(71) Applicant: Apple Inc., Cupertino, CA (US)

(72) Inventors: Itay Sagron, Herzliya (IL); Assaf Shappir, Herzliya (IL); Evgeniy Braginskiy, Herzliya (IL)

(21) Appl. No.: 19/459,008

(22) Filed: Jan. 26, 2026

Related U.S. Application Data
(60) Provisional application No. 63/756,165, filed on Feb. 9, 2025.

(51) Int. Cl. G06F 3/06

(52) U.S. Cl. CPC G06F 3/0611; G06F 3/0659; G06F 3/0679

(57) ABSTRACT

An apparatus includes a memory and a processor. The memory includes multi-level cell (MLC) memory cells, the memory configured to store in the memory cells (i) first bits having a first readout latency, and (ii) second bits having a second readout latency that is larger than the first readout latency. The processor is configured to determine, for data to be stored in the memory, whether the data is to be read with the first or second readout latency. In response to determining that the data is to be read with the first readout latency, the processor is configured to store one or more of the first bits in accordance with the data. In response to determining that the data is to be read with the second readout latency, the processor is configured to store one or more of the second bits in accordance with the data.

### CROSS-REFERENCE TO RELATED APPLICATIONS

This application claims the benefit of U.S. Provisional Patent Application 63/756,165, filed Feb. 9, 2025, whose disclosure is incorporated herein by reference.

### FIELD OF THE DISCLOSURE

The present disclosure relates to non-volatile memory storage systems, and, more particularly, to hybrid memory block structures.

### BACKGROUND OF THE DISCLOSURE

NAND flash memory has become a dominant storage technology in modern computing devices, including mobile platforms, consumer computers, and enterprise storage systems. NAND flash memory stores data by trapping electrons in floating gate or charge trap structures, with different voltage threshold levels representing different data states. A single-level cell (SLC) stores one bit per cell using two voltage states, while triple-level cell (TLC) stores three bits per cell using eight voltage states, and quad-level cell (QLC) stores four bits per cell using sixteen voltage states. The commonly used term for two-bit-per cell is MLC; however, as this term is also used for generic multi-level cells, we will use hereinbelow the term MLC exclusively for multi-level cells, including 2, 3, 4 and any other suitable number of bits per cell.

Reading data from multi-level NAND flash memory involves sensing operations that compare the cell's threshold voltage against reference voltages to determine the stored data. For improved reliability (better bit error rate, or BER), the binary data to be stored is typically converted to a Gray code.

Background on using Gray-codes in MLC flash memories can be found for example, in “Coding for Non-Volatile Memory Technologies: Theoretical Advances and Practical Considerations”, Dolecek and Cassuto (Proceedings of the IEEE, Volume 105 Issue 9, September 2017). In this article, the authors assert that every bit of information in a storage or memory device is bound by a multitude of performance specifications, and is subject to a variety of reliability impediments, while, on the other end, the physical processes that are optimized to remember data bits offer a constant reliability risk, including a variety of noise sources, access restrictions, intercell interferences, cell variabilities, and others. Channel coding schemes are used to ensure target reliability and performance. The authors then overview the fundamentals of channel coding and summarize well-known codes that have been used in nonvolatile memories (NVMs), demonstrate the limitations of symmetric-channel-based conventional coding, and continue to discuss several recently proposed innovative coding schemes.

More background can be found in U.S. Pat. No. 5,450,363, which discloses a memory system containing a plurality of memory cells, a sensing circuit, and a translator circuit. The memory cells store one of a plurality of threshold levels, wherein the threshold levels demarcate windows for designating more than a single bit of data for each memory cell. The sensing circuit, coupled to the memory cells, generates at least one binary coded bit from the threshold level sensed. A translator circuit translates the binary coded bits to Gray coded bits such that only one bit changes state between adjacent threshold levels.

In conventional TLC implementations, a balanced Gray-code mapping such as a 2-3-2 scheme distributes sensing operations relatively evenly across page types, with the least significant bit (LSB) page requiring two sensing operations, the most significant bit (MSB) page requiring three sensing operations, and the upper significant bit (USB) page requiring two sensing operations.

### SUMMARY OF THE DISCLOSURE

An embodiment that is described herein provides an apparatus including a memory and a processor. The memory includes multi-level cell (MLC) memory cells, the memory configured to store in the memory cells (i) first bits having a first readout latency, and (ii) second bits having a second readout latency that is larger than the first readout latency. The processor is configured to determine, for data to be stored in the memory, whether the data is to be read with the first or second readout latency. In response to determining that the data is to be read with the first readout latency, the processor is configured to store one or more of the first bits in accordance with the data. In response to determining that the data is to be read with the second readout latency, the processor is configured to store one or more of the second bits in accordance with the data.

In some embodiments, the processor is configured to initially buffer the data in a temporary location in the memory, and to subsequently store, in the memory cells, combined first and second bits according to the buffered data. In other embodiments, the processor is configured to initially buffer the data in a Random Access Memory (RAM) that is different from the memory, and to subsequently store, in the memory cells, combined first and second bits according to the buffered data. In an embodiment, to store the first bits, the processor is configured to write the data to one or more Least-Significant Bit (LSB) pages of the memory.

In a disclosed embodiment, the memory is configured to read the first bits using a first number of threshold comparisons, and to read the second bits using a second number of threshold comparisons, larger than the first number. In an example embodiment, the memory is configured to read the first bits using a single threshold comparison. In an embodiment, the memory is configured to map the data to MLC programming levels using Gray coding.

In disclosed embodiments, the processor is configured to move a portion of the data between pages of the memory that are read with the first latency and pages of the memory that are read with the second latency, thereby improving performance of the apparatus. In an embodiment, the processor is configured to control a write buffer in the memory for storing new data. In an embodiment, the processor is configured to delete low priority data that is stored in the memory, to improve performance of the apparatus.

There is additionally provided, in accordance with an embodiment that is described herein, a method including receiving or generating data to be stored in a memory comprising multi-level cell (MLC) memory cells, the memory configured to store in the memory cells (i) first bits having a first readout latency, and (ii) second bits having a second readout latency that is larger than the first readout latency. A determination is made whether the data is to be read with the first or second readout latency. In response to determining that the data is to be read with the first readout latency, one or more of the first bits are stored in accordance with the data. In response to determining that the data is to be read with the second readout latency, one or more of the second bits are stored in accordance with the data.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates an integrated circuit (IC) configured for hybrid block data storage in NAND flash memory, in accordance with an embodiment that is described herein;

FIG. 2 is a block diagram that schematically illustrates a TLC memory architecture for organizing data within TLC NAND memory, in accordance with an embodiment that is described herein;

FIG. 3 is a block diagram that schematically illustrates a QLC memory architecture, for organizing data within a multi-level NAND memory, in accordance with an embodiment that is described herein;

FIG. 4 is a flowchart that schematically illustrates a method for programming data into a multi-level NAND flash memory using an unbalanced Gray-code scheme, in accordance with an embodiment that is described herein;

FIG. 5 is a diagram that schematically illustrates various types of systems that may include any of the circuits, devices, or system discussed above, in accordance with embodiments that are described herein; and

FIG. 6 is a block diagram illustrating an example non-transitory computer-readable storage medium that stores circuit design information, according to some embodiments that are described herein.

### DESCRIPTION OF EMBODIMENTS

### Overview

Embodiments that are described herein provide a multi-level-cell (MLC) non-volatile memory (NVM), such as a NAND flash, that provides fast access time to selected pages therein.

In embodiments, an apparatus, such as an IC or a multi-chip electronic device (will be referred to as an Electronic Device) comprises an MLC memory. The MLC memory provides different access times for the multiple bits that are stored in each cell. A processor utilizes the uneven access time to define fast pages that are stored in the fast access-time bits.

In a disclosed embodiment, an IC comprises a TLC NAND flash, programmed using 1-3-3 Gray-code that requires one comparison operation to resolve a first bit, and three comparison operations to resolve each of the other two bits (in other embodiments, other non-balanced schemes may be used, e.g., 2-3-2). The electronic device further comprises circuitry to read, write and erase the memory, under the control of a processor that executes a Flash-Translation Layer (FTL) code. For storing new data into the NAND flash, the electronic device (typically the FTL code) further comprises a bit-assembly circuit, that is configured to group a single fast bit and two slow bits, for storage into each one of the memory cells.

In a TLC embodiment that is further disclosed, a NAND flash comprises TLC coded regions; a resident data region and a new data region, both 2-3-2 coded and featuring medium access time, and a 1-3-3 region, divided into a fast-access page and two slow-access pages, wherein the fast page comprises the LS bits of the memory cells in the region. In some embodiments, the NAND flash is designed to operate with a 2-3-2 Gray code, which is manipulated to operate in 1-3-3 Gray code by special command sequences and data manipulation, either within the NAND flash or by the memory controller.

In another embodiment that is disclosed herein, a NAND flash is divided into high density QLC region and lower density 1-3-3 TLC region, the latter comprising a fast page and two slower pages.

Thus, in embodiments, non-uniform access time of MLC flash cells can be utilized to define faster and slower memory pages.

### DETAILED DESCRIPTION OF EMBODIMENTS

In multi-level NAND flash memory, data is stored by programming memory cells to different voltage levels. To reliably distinguish between these levels during read operations and to minimize bit errors when voltage distributions overlap or shift, channel coding schemes such as Gray-codes are employed. The number of voltage sensing operations required to read data from a memory cell directly impacts read latency, with more sensing operations resulting in longer access times.

The present disclosure builds upon the observation that certain bits stored in multi-level cells may be read faster than others, e.g., with fewer voltage sensing operations. By assigning data requiring fast access to pages associated with these faster-reading bits, improved read bandwidth for those pages may be achieved without sacrificing storage density. In some embodiments, unbalanced (non-uniform) Gray-coding schemes may be employed in which a small number of threshold voltage comparisons (e.g., a single comparison) is sufficient to detect one of the multi-level bits of the cell.

In the description below we will designate the binary bits of the stored data words as follows:
TLC (three bits per cell): L-C-M (L is the least significant, representing 2^{Θ}, C represents 2¹ and M represents 2²).
QLC (four bits per cell): L-M-U-T (L is the least significant, representing 2^{θ}, M represents 2¹, U represents 2² and T represents 2³).

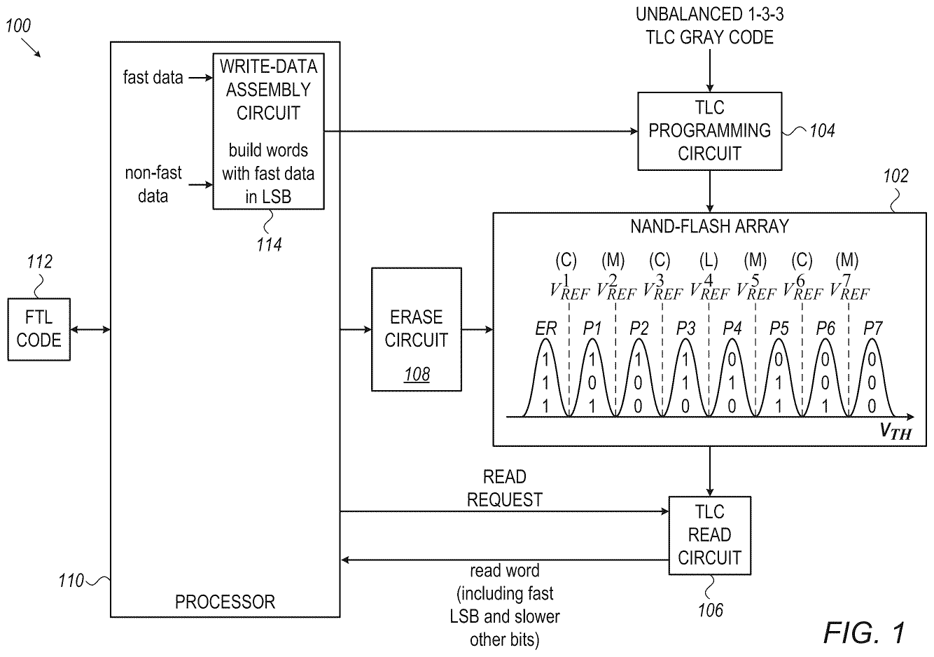

FIG. 1 is a block diagram that schematically illustrates an integrated circuit (IC) 100 configured for hybrid block data storage in NAND flash memory, in accordance with an embodiment that is described herein. IC 100 comprises a multi-level NAND-flash array 102, a Three-Level-Cell (TLC) programming circuit 104, a TLC read circuit 106, an erase circuit 108, a processor 110, a File-Translation Layer (FTL) code 112, and a write-data assembly circuit 114. The access time of the three multi-level memory cells bits are unequal.

Each of the memory cells of NAND flash array 102 may be set to one of eight states: an erased state (ER) and seven programmed states P1 through P7. Seven reference voltages, marked Vref₁ through Vref₇, are defined at positions between adjacent states. Each of the eight states is labeled by a three-letter code, to indicate its association with Gray-encoded bits, including lower (L), center (C) and middle (M). The voltage level distribution shows the unbalanced Gray-code mapping where the LSB requires only a single comparison operation at the reference voltage between states P3 and P4, and, hence, the access time for the least significant bit (LSB) is shorter than that of the other two bits. In an embodiment, fast and non-fast memory pages are defined based on this inequality.

Write-data assembly circuit 114 is configured to receive both fast and slower data as inputs and to assemble 3-bit words with fast data in the least-significant bit (LSB) position. The output of the write-data assembly circuit is input to the TLC programming circuit, which also receives an unbalanced 1-3-3 TLC Gray-code. The TLC programming circuit converts the 3-bit words into corresponding 3-bit Gray-coded words, and programs the memory cell to one of eight levels, according to the 3-bit Gray-coded word (in some embodiments, when the Gray-coded word indicates the lowest programming level, the TLC programing circuit will refrain from programming the cell, which will remain erased).

Erase circuit 108 is coupled to the NAND-flash array 102 and performs erase operations on the memory cells or on parts thereof. In some embodiments, the erase circuit is configured to apply a series of erase-voltage pulses to reset selected blocks in the memory array; in an embodiment, the erase process is iterative.

TLC read circuit 106 is coupled to the NAND-flash array 102. The TLC read circuit, responsively to a read request, reads words from the NAND-flash array 102, including fast LSB bits and slower other bits, and provides the read data to processor 110.

As described above, when a word is read from the memory cell, the LSB value is determined after one threshold comparison, and is, thus, faster than the values of the other bits, which are determined after a sequence of three comparisons.

Processor 110 is coupled to the TLC read circuit and to the FTL code. The FTL code manages file translation layer operations, including discriminating between data requiring fast access and data with lower performance priority.

We will refer below to the page types according to the respective bit positions in the TLC-the fast access page, comprising LS bits, will be also referred to as the L-type page; the other two pages will be referred to as the M-type and the C-type pages.

Thus, according to the example embodiment illustrated in FIG. 1, processor 100 may support fast pages and slower pages, according to the access times of the three bits of the three-level cells; this is achieved by 1-3-3 Gray-coding.

The configuration of processor 100 illustrated in FIG. 1 and described hereinabove is cited by way of example. Other embodiments may be used in alternative embodiments. For example, in an embodiment, other codes that discriminate between the access time of the bits may be employed, instead of the 1-3-3 Gray code, including, for example, 2-3-2, where each of the L and the M pages needs two comparisons, and the C page requires three comparisons. In another example embodiments, 2-3-2 Gray code is used, and additional trimming circuitry is employed to make the L page faster than the M page.

In some embodiments, other multi-level storage schemes may be used, including 2, 4 and more bits per cell. In other embodiments, write-data assembly circuit 114 may be implemented in software; in an embodiment, the functionality of write data circuit 114 is embedded in the FTL code.

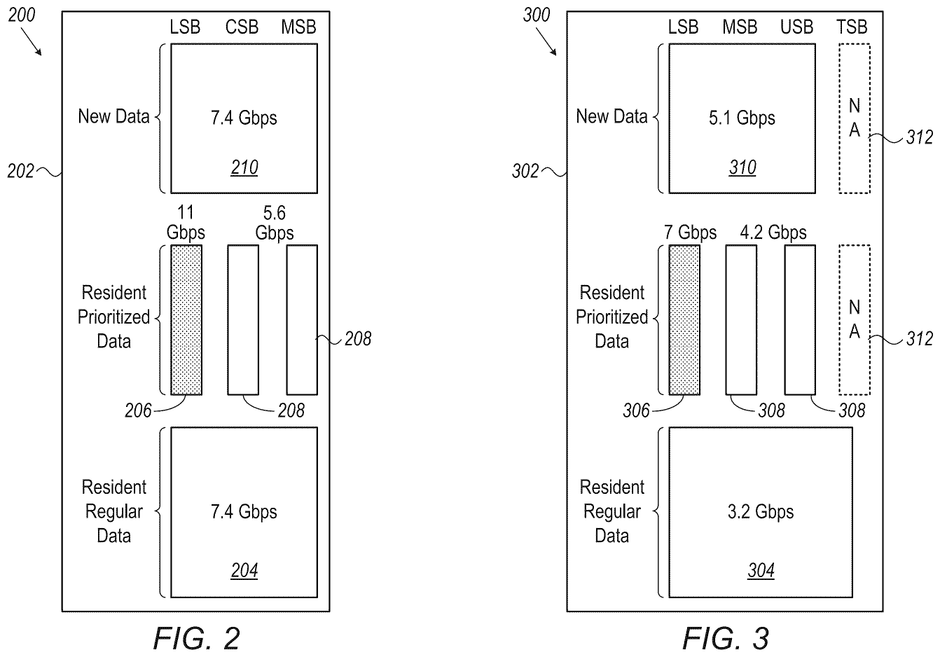

FIG. 2 is a block diagram that schematically illustrates a TLC memory architecture 200 for organizing data within TLC NAND memory 202, in accordance with an embodiment that is described herein. According to the example embodiment illustrated in FIG. 2, The TLC NAND memory is divided into distinct regions based on data type and access priority. A resident regular data region 204 stores non-prioritized resident data. A prioritized data-region 206 stores data requiring fast read access (e.g., L pages, comprising the least-significant bits of the TL cells) and operates at higher read bandwidth than non-prioritized data regions 208, which store data with lower performance priority (for example, in the M and the C bits). A new-data region 210 stores recently-written data and includes LSB, MSB, and CSB pages. In operation, new data is initially written into the new data region 210. Later, when the storage is not busy, for example during garbage collection operations, the data may be grouped according to access priority and written into the prioritized data region 206 and non-prioritized data regions 208, accordingly (it should be noted that regions 206 and 308 employ different page types which are programmed simultaneously, but are physically stored in the same memory block).

In embodiments, the processor is configured to manage the memory for reduced latency of critical memory segments, thereby improving the performance of the electronic device. For example, in some embodiments, the processor is configured to reorganize data by moving portions of the memory between fast and slow pages (fast and slower latencies), and to keep a write buffer available for new data. In embodiments, the processor is configured to delete low priority data that is stored in the memory, such as temporary data or OS updates, and to use the cleared area for fast access data, or for additional write buffer space.

According to the example embodiment illustrated in FIG. 2, data stored in either resident regular data region 204 or new-data region 210 can be read at a rate of 7.4 Gbps. Non-prioritized data in non-prioritized data region 208 is read slightly slower, at 5.6 Gbps, and prioritized data region 206 can be read at a fast rate of 11 Gbps. In an embodiment, a single threshold comparison is needed to read a prioritized data region bit, wherein, for a non-prioritized data region, three comparisons are needed to READ each bit. For the new data region 210, an average of (1+3+3/3=2.33 threshold comparisons are needed for each bit read (same as the 2-3-2 Gray code case).

Thus, according to the example embodiment illustrated in FIG. 2 and described hereinabove, TLC memory architecture 200 separates data based on access priority, with the prioritized data region 206 providing faster read performance compared to the non-prioritized data regions 208 and the resident regular data region 204.

In embodiments, memory management that avoids priority region exhaustion is of high importance-if the priority region runs out, priority data will be written in slower regions; in this case, read-speed will be averaged out similar to standard NAND. Moreover, for QLC, an additional step will be needed, where data in the TLC region is transferred, due to lack of space, to the QLC region, further slowing-down the read operation.

The configuration of TLC memory architecture 200 illustrated in FIG. 2 and described hereinabove is cited by way of example. Other configurations may be used in alternative embodiments. For example, in some embodiments, there is no new data region 210; instead, new data is written to a Random Access Memory (RAM) and later copied to either non-prioritized data region 208, prioritized data region 206 or resident data region 204. In an embodiment, new data may be written to RAM and, when the RAM fills up, to new data region 210; in yet other embodiments there is no resident data segment 204. In embodiments, the read rates for the various regions may be different from the quoted values.

### Serial vs. Parallel Programming

In a preferred embodiment, the multi-level programming voltages of the Flash cells may be prepared by assembling values of all bits and then building a corresponding programming voltage to store a respective charge in the Flash cell. In some embodiments, however, an alternative serial programing approach is taken, wherein, starting with an erased cell, the bits are programmed serially. For example, in TLC, a programming circuit stores a charge corresponding to half the cell capacity if the most-significant bit is at logic-1 and then, if the next bit is at logic-1, stores a charge corresponding to a quarter of the cell capacity, and, finally, if the LSB is at logic-1, stores a charge corresponding to an eighth of the cell capacity. In embodiments, the bit programming order may change. This technique has the advantage that the bit-assembly circuit is not needed, but it assumes linearity, which is not always true.

In some embodiments, to mitigate the effects of cross coupling between neighbor cells, other programming techniques may be used.

### Prioritized Pages in QLC

The techniques described above can be directly expanded for multi-level cells other than TLC. For quad-level-cells (QLCs), for example, rather than the balanced 3-4-4-4 Gray-code (which only slightly favors the LSB over other bits), more aggressive Gray configurations like 2-5-4-4 or even 1-5-5-4 may be used.

As QLC memory utilizes 16 threshold voltages, the reliability margins are small and, hence, bit errors are more common. Bit errors further increase when more levels are needed to sense the data in the cell, and, hence, unbalanced Gray codes in QLC are usually avoided. Thus, operating some cells (blocks) in TLC mode allows better reliability margins, enables faster sensing speeds in addition to providing fast write operation (fewer threshold levels need to be programmed).

In some embodiments, part of the memory uses 1-3-3 TLC coding with fast and slow pages, while another part of the memory uses balanced 3-4-4-4 QLC, for higher density.

FIG. 3 is a block diagram that schematically illustrates a QLC memory architecture 300, for organizing data within a multi-level NAND memory, in accordance with an embodiment that is described herein. A multi-level NAND memory 302 comprises a high-density resident data QLC region; in some embodiments the QLC data in region 304 may comprise balanced 3-4-4-4 Gray coding.

For prioritized data pages, memory 302 comprises lower density TLC regions, including a high priority data region 306 for maximally prioritized data requiring the fastest read access, two lower priority data regions 308 for medium prioritized data operating at slower read bandwidths and a new data region 310 for recently written data. In the TLC-coded regions 306, 308 and 310, all cells are programmed, but with three rather than four bit-per-cell; the unused space (compared to QLC coding) is symbolically represented by regions 312.

In operation, new data is initially written to the new data region 310. Later, when the storage is not busy, for example during idle period, or for another example, during garbage collection operations, the data may be grouped according to access priority and written into the first priority data region 306 and the second priority data regions 308, accordingly. The new data region 310 may then be erased, in preparation for more new data.

Thus, according to the example embodiment illustrated in FIG. 3, a multi-level NAND memory can be organized to provide different performance tiers for different data types, including a maximum density medium speed QLC region, medium-density fast-access and medium-access regions, and, in an embodiment, including a dedicated TLC region for new unsorted data that is to be prioritized.

The configuration of QLC memory architecture 300 illustrated in FIG. 3 and described hereinabove is cited by way of example. Other configurations may be used in alternative embodiments. For example, in some embodiments new data region 310 is QLC-organized. In other embodiments, there is no new data region and, instead, new data is stored in RAM. In an embodiment, the fast access region comprises a QLC page with a single voltage sense, such as the LSB page in a 1-5-5-4 Gray code, with no density loss. In another embodiment the fast access region comprises one or two MLC pages with 50% density loss (compared to QLC), and, in yet another embodiment, the fast access region comprises an SLC page, providing the fastest access speed with a 75% density loss vs. QLC.

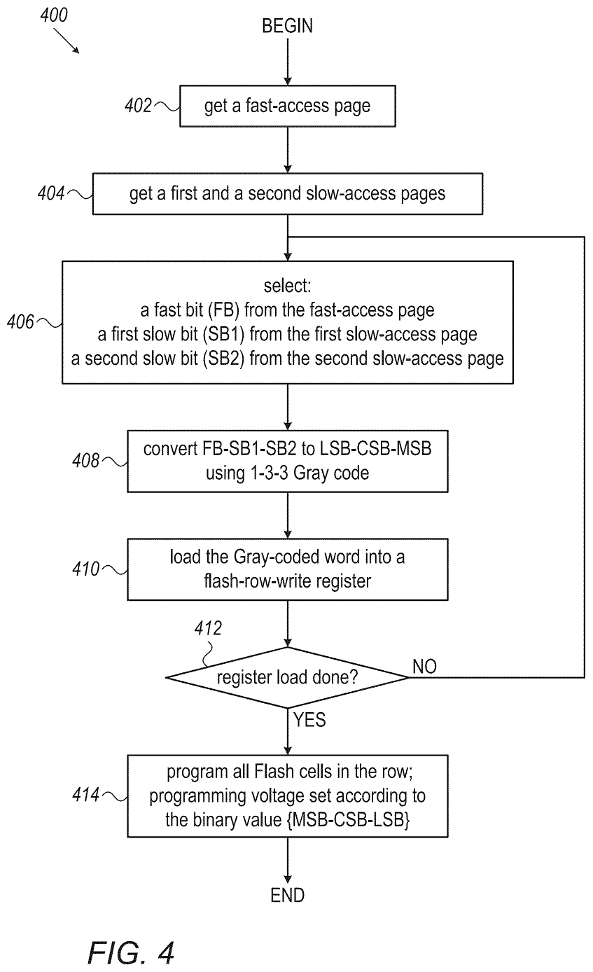

FIG. 4 is a flowchart that schematically illustrates a method 400 for programming data into a multi-level NAND flash memory using an unbalanced 1-3-3 Gray-code scheme, in accordance with an embodiment that is described herein. The flowchart is executed by a processor (e.g., processor 110, FIG. 1) that runs a suitable FTL code. The flowchart pertains to the programming of a single flash row, comprising a fast page and two slow pages. For programming multiple flash rows, for programming a row that spans more than a fast page and two slow pages, or for programming pages that span multiple rows, the flowchart should be modified accordingly (in some embodiments, the processor sends the data page by page, and rearrangement is done by hardware circuitry).

The flowchart begins at a get fast-access page operation 402, wherein a high priority fast-access page is obtained. The flowchart then proceeds to a get slower-access pages operation 404, wherein a first and a second slow-access pages are obtained. Next, the flowchart enters a select bits operation 406, where one fast bit is selected from the fast-access page, one slow bit is selected from the first slow-access page, and one slow bit is selected from the second slow-access page. The flowchart now proceeds to a 1-3-3 Gray conversion operation 408, wherein the selected bits are converted to Least Significant Bit, Center-Significant Bit, and Most Significant Bit format, using a 1-3-3 Gray code.

Next, the flowchart enters a load-into-register operation 410, where the converted bits are loaded into a flash-row-write register. The flowchart then reaches a check-register-load-done operation 412, which determines whether the full register (typically storing a full line data) has been written. If register loading is not done, the flowchart returns to select bits operation 406, to continue processing additional bits. If register loading is done, the flowchart proceeds to a programming operation 414, wherein all flash cells in the row are programmed with the programming voltage set according to the binary value of the Gray-converted bits, and the flowchart ends.

Thus, according to the example flowchart illustrated in FIG. 4 and described hereinabove, the unbalanced 1-3-3 Gray code mapping enables mixing of fast and slower access time pages in the same TLC memory.

The configuration of flowchart 400 illustrated in FIG. 4 and described hereinabove is cited by way of example. Other configurations may be used in alternative embodiments. For example, in some embodiments, QLC or other coding schemes may be used. In some embodiments, bits are programmed serially. In some embodiments, the processor writes multiple pages into registers prior to the programming operation, which may be done in parallel to large portions of the memory,

Although the embodiments described herein mainly address hybrid block structure in a NAND flash, the techniques described herein can also be used in other applications, such as other memory types, including, for example, NOR flash. In addition, the techniques may be used in any memory technology implementing a multi-level cell approach, including and not limited to RRAM, PCM, MRAM and FeRAM.

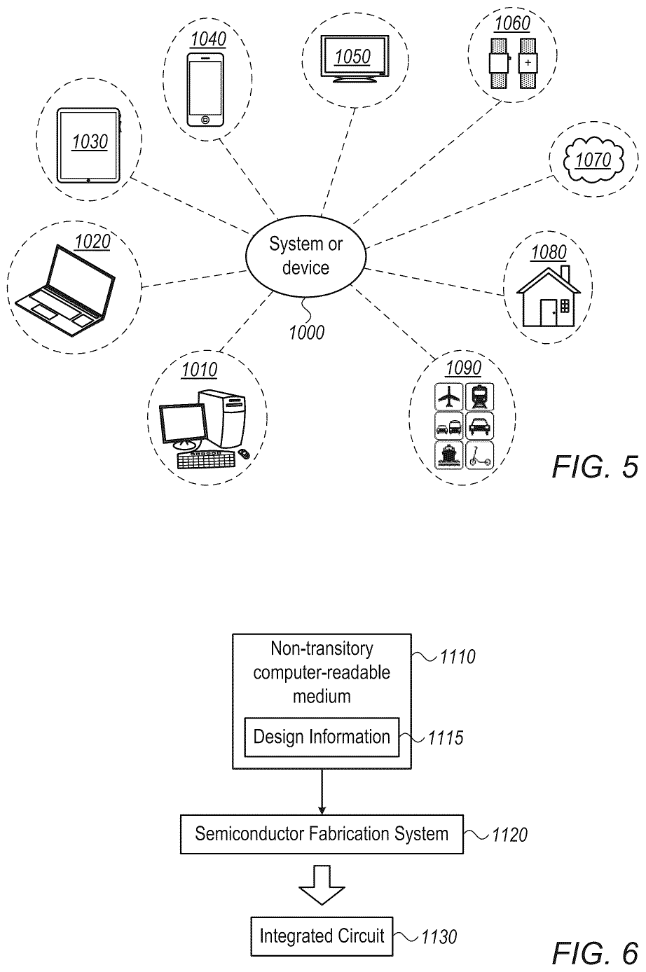

FIG. 5 is a diagram 1000 that schematically illustrates various types of systems that may include any of the circuits, devices, or system discussed above, in accordance with embodiments that are described herein.

System or device 1000, which may incorporate or otherwise utilize one or more of the techniques described herein, may be utilized in a wide range of areas. For example, system or device 1000 may be utilized as part of the hardware of systems such as a desktop computer 1010, laptop computer 1020, tablet computer 1030, cellular or mobile phone 1040, or television 1050 (or set-top box coupled to a television).

Similarly, disclosed elements may be utilized in a wearable device 1060, such as a smartwatch or a health-monitoring device. Smartwatches, in many embodiments, may implement a variety of different functions, for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1000 may also be used in various other contexts. For example, system or device 1000 may be utilized in the context of a server computer system, such as a dedicated server or on shared hardware that implements a cloud-based service 1070. Still further, system or device 1000 may be implemented in a wide range of specialized everyday devices, including devices 10100 commonly found in the home such as refrigerators, thermostats, security cameras, etc. The interconnection of such devices is often referred to as the “Internet of Things” (IoT). Elements may also be implemented in various modes of transportation. For example, system or device 1000 could be employed in the control systems, guidance systems, entertainment systems, etc. of various types of vehicles 1110.

The applications illustrated in FIG. 5 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that is recognized by a fabrication system configured to produce hardware (e.g., an integrated circuit) that includes the disclosed circuitry. Claims to such a storage medium are intended to cover, for example, an entity that produces a circuit design, but does not itself fabricate the design.

FIG. 6 is a block diagram illustrating an example non-transitory computer-readable storage medium that stores circuit design information, according to some embodiments that are described herein. In the illustrated embodiment semiconductor fabrication system 1120 is configured to process the design information 1115 stored on non-transitory computer-readable medium 1110 and fabricate integrated circuit 1130 based on the design information 1115.

Non-transitory computer-readable storage medium 1110, may include any of various appropriate types of memory devices or storage devices. Non-transitory computer-readable storage medium 1110 may be an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1110 may include other types of non-transitory memory as well or combinations thereof. Non-transitory computer-readable storage medium 1110 may include two or more memory mediums which may reside in different locations, e.g., in different computer systems that are connected over a network.

Design information 1115 may be specified using any of various appropriate computer languages, including hardware description languages such as, without limitation: VHDL, Verilog, SystemC, SystemVerilog, RHDL, M, MyHDL, etc. Design information 1115 may be usable by semiconductor fabrication system 1120 to fabricate at least a portion of integrated circuit 1130. The format of design information 1115 may be recognized by at least one semiconductor fabrication system 1120. In some embodiments, design information 1115 may also include one or more cell libraries which specify the synthesis, layout, or both of integrated circuit 1130. In some embodiments, the design information is specified in whole or in part in the form of a netlist that specifies cell library elements and their connectivity. Design information 1115, taken alone, may or may not include sufficient information for fabrication of a corresponding integrated circuit. For example, design information 1115 may specify the circuit elements to be fabricated but not their physical layout. In this case, design information 1115 may need to be combined with layout information to actually fabricate the specified circuitry.

Integrated circuit 1130 may, in various embodiments, include one or more custom macrocells, such as memories, analog or mixed-signal circuits, and the like. In such cases, design information 1115 may include information related to included macrocells. Such information may include, without limitation, schematics capture database, mask design data, behavioral models, and device or transistor level netlists. As used herein, mask design data may be formatted according to graphic data system (GDSII), or any other suitable format.

Semiconductor fabrication system 1120 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1120 may also be configured to perform various testing of fabricated circuits for correct operation.

In various embodiments, integrated circuit 1130 is configured to operate according to a circuit design specified by design information 1115, which may include performing any of the functionality described herein. For example, integrated circuit 1130 may include any of various elements shown in FIGS. 1 through 4. Further, integrated circuit 1130 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § [0-9] {3} (f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
a memory comprising multi-level cell (MLC) memory cells, the memory configured to store in the memory cells (i) first bits having a first readout latency, and (ii) second bits having a second readout latency that is larger than the first readout latency; and
a processor, configured to:
determine, for data to be stored in the memory, whether the data is to be read with the first or second readout latency;
in response to determining that the data is to be read with the first readout latency, store one or more of the first bits in accordance with the data; and
in response to determining that the data is to be read with the second readout latency, store one or more of the second bits in accordance with the data.

2. The apparatus according to claim 1, wherein the processor is configured to initially buffer the data in a temporary location in the memory, and to subsequently store, in the memory cells, combined first and second bits according to the buffered data.

3. The apparatus according to claim 1, wherein the processor is configured to initially buffer the data in a Random Access Memory (RAM) that is different from the memory, and to subsequently store, in the memory cells, combined first and second bits according to the buffered data.

4. The apparatus according to claim 1, wherein, to store the first bits, the processor is configured to write the data to one or more Least-Significant Bit (LSB) pages of the memory.

5. The apparatus according to claim 1, wherein the memory is configured to read the first bits using a first number of threshold comparisons, and to read the second bits using a second number of threshold comparisons, larger than the first number.

6. The apparatus according to claim 1, wherein the memory is configured to read the first bits using a single threshold comparison.

7. The apparatus according to claim 1, wherein the memory is configured to map the data to MLC programming levels using Gray coding.

8. The apparatus according to claim 1, wherein the processor is configured to move a portion of the data between pages of the memory that are read with the first latency and pages of the memory that are read with the second latency, thereby improving performance of the apparatus.

9. The apparatus according to claim 1, wherein the processor is configured to control a write buffer in the memory for storing new data.

10. The apparatus according to claim 1, wherein the processor is configured to delete low priority data that is stored in the memory, to improve performance of the apparatus.

11. A method, comprising:
receiving or generating data to be stored in a memory comprising multi-level cell (MLC) memory cells, the memory configured to store in the memory cells (i) first bits having a first readout latency, and (ii) second bits having a second readout latency that is larger than the first readout latency;
determining whether the data is to be read with the first or second readout latency;
in response to determining that the data is to be read with the first readout latency, storing one or more of the first bits in accordance with the data; and
in response to determining that the data is to be read with the second readout latency, storing one or more of the second bits in accordance with the data.

12. The method according to claim 11, wherein storing the first bits and the second bits comprises initially buffering the data in a temporary location in the memory, and subsequently storing, in the memory cells, combined first and second bits according to the buffered data.

13. The method according to claim 11, wherein storing the first bits and the second bits comprises initially buffering the data in a Random Access Memory (RAM) that is different from the memory, and subsequently storing, in the memory cells, combined first and second bits according to the buffered data.

14. The method according to claim 11, wherein storing the first bits comprises writing the data to one or more Least-Significant Bit (LSB) pages of the memory.

15. The method according to claim 11, wherein the memory reads the first bits using a first number of threshold comparisons, and reads the second bits using a second number of threshold comparisons, larger than the first number.

16. The method according to claim 11, wherein the memory reads the first bits using a single threshold comparison.

17. The method according to claim 11, wherein the memory maps the data to MLC programming levels using Gray coding.

18. The method according to claim 11, further comprising moving a portion of the data between pages of the memory that are read with the first latency and pages of the memory that are read with the second latency, thereby improving performance of the apparatus.

19. The method according to claim 11, further comprising controlling a write buffer in the memory for storing new data.

20. The method according to claim 11, further comprising deleting low priority data that is stored in the memory, to improve performance of the apparatus.
